(19) United States
(12) Patent Application Publication
(10) Pub. No.: US 2016/0027259 A1
(43) Pub. Date: Jan. 28, 2016

(54) Method for Creating, Increasing and Retaining Fan Engagement during Tournament Play

(71) Applicant: Cordell Jeffries, Webster Groves, MO (US)

(72) Inventor: Cordell Jeffries, Webster Groves, MO (US)

(21) Appl. No.: 14/809,189

(22) Filed: Jul. 25, 2015

Related U.S. Application Data
(60) Provisional application No. 62/029,384, filed on Jul. 25, 2014.

(51) Int. Cl. G07F 17/32

(52) U.S. Cl. CPC G07F 17/3276; G07F 17/3288; G07F 17/3255; G07F 17/3237

(57) ABSTRACT

A method for creating and preserving interest and participation in a tournament wherein both casual and serious fans leverage participation in simple and complex prediction brackets respectively. Serious fans fill out a complete prediction bracket at the outset of the sports tournament. Casual fans fill out a partial prediction bracket at the outset of the tournament. The partial prediction bracket is for a much later round of the tournament. At the much later tournament round, both casual and serious fans are provided one or more opportunities to update and correct their team selections to enhance their competitive predictive standing for the remainder of the tournament. Based on results of the tournament, each participant receives a ranking based upon one or more point systems as determined by sponsors of the particular bracket competition.

### CROSS REFERENCE TO RELATED APPLICATIONS

This application claims the benefit of U.S. Provisional Application No. 62/029,384, filed Jul. 25, 2014.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD OF THE INVENTION

The invention relates to methods for creating, increasing and retaining fan engagement and attention during the course of a tournament. More particularly, the invention relates to such methods associated with the use of brackets in tracking the outcomes of a tournament.

### BACKGROUND

The use of brackets to track winners and losers in a competitive tournament is well known. A bracket is a tree diagram that represents the series of games played during a tournament, named as such because it appears to be a large number of interconnected brackets. Originally developed as simply a means to track outcomes of competitive events, brackets have evolved to form the foundation of advertising efforts by significant entities.

There are several kinds of brackets, adapted to different types of tournaments. The most common include single-elimination or double-elimination brackets. The process and study of filling in brackets, especially in American college basketball, is generally referred to as “bracketology,” a term purportedly coined by ESPN's Joe Lunardi. Over time, advertisers have come to realize that the promotion of these brackets with fans for tournament play has created a new tool to bring eyes to their advertisements. The National Collegiate Athletic Association (NCAA), for example, has created an advertising and promotion strategy that revolves around the use of a bracket associated with the NCAA Men's Division 1 basketball tournament, marketed under the trademark “MARCH MADNESS.”

Brackets are commonly used to track both professional and college sports. Typically, at the end of a regular season, a league holds a post-season tournament to determine which team is the best out of all of the other teams in the league. In professional sports in the U.S., there are typically two different conferences, and teams mostly play other teams in their own conference. Examples of this are the American Football Conference and the National Football Conference in the NFL, the American League and the National League in Major League Baseball, and the Eastern Conference and the Western Conference in the NBA or NHL.

When there are only two different conferences, there are typically two sides of a bracket. One conference is on one side, while the other is on the opposite side. Each side is typically organized according to a team's seeding; higher-seeded teams are matched against lower-seeded teams. Teams that qualify for the post-season tournament only compete against teams in their own conference, until only one team from each conference remains. These two teams, called the conference champions, play each other to determine the best in the league. Other leagues, like the NHL, also have two conferences, each of which is divided into divisions, usually by region. In the post-season tournament, only the teams with the best records qualify, with the exception of the division leader having an automatic entry into the tournament.

The concept of brackets is even more visible in college sports, most notably in reference to the NCAA Men's Division I Basketball Championship. The NCAA has promoted this tournament to a level where millions of casual and serious fans “fill out brackets” to predict the winners of each game in the tournament. These brackets are filled out for both formal contests, sponsored by various corporations, and informal betting pools among friends or work colleagues. Due to the number of teams, the bracket for the NCAA basketball tournament is much larger than those for North American professional sports leagues. While no more than 16 teams qualify for the postseason in any major North American league (NBA and NHL), 68 teams (out of over 350) advance to the NCAA men's tournament, with most bracket contests involving 64 of these teams. The concept of bracketology in association with use in the NCAA tournament is sufficiently popular that once a year, Saint Joseph's University offers an online course to teach the principles of bracketology as applied to Division I college basketball and the NCAA men's basketball championship.

Despite the popularity of generating individual brackets for tracking tournament play, the complexity, detail and time associated with completing a full bracket tends to be intimidating to those other than the most die-hard fans of a particular sport. Hence, casual fans are less likely to become fully engaged with a complete bracket and therefore, advertisers will not be as able to capture the attention and engagement of these casual fans during the course of the tournament. Casual fans may elect to wait until the tournament has reached the championship game to pay attention to the contest. As a result, advertisers are only able to engage the attention of these casual fans during the final championship contest. This reduces the opportunity for sponsors and promoters supporting the tournament to reach potential consumers of their products.

In addition, even for the serious fan willing to participate in the generation of a full bracket for the tournament, once their selected teams have lost during the course of the tournament, the serious fan may likewise lose interest in following the tournament as closely. Consequently, the advertisers, sponsors and promoters of the event will once again lose valuable eyes and minds on their products.

In one effort to extend interest throughout a tournament, the NCAA has expanded branding associated with the MARCH MADNESS basketball tournament by coining additional phrases referring to various stages in the tournament, such as the trademarks “SWEET SIXTEEN” to describe the round of sixteen teams, “ELITE EIGHT” to describe the round of eight teams, and “FINAL FOUR” to describe the round of four teams. However, this articulated, segmented branding approach merely serves as a means for additional promotion of the entire tournament. The extended branding does not necessarily fully engage the attention of the casual fan that has not elected to fill out a full bracket.

In addition, various parties have attempted to simplify the ability for fans to fill out their individual brackets by providing online software solutions or smartphone applications.

However, these online and mobile solutions still require significant time to use and hence, are typically attractive only to the serious fan. Further, these online and mobile solutions still suffer from an inability to retain the attention and engagement of both serious and casual fans when their favorite teams have been knocked out of the tournament. These software solutions are less likely to be used by the casual fan that has little desire to spend the time and effort to fill out and complete a full bracket.

Therefore, it would be highly advantageous for advertisers, sponsors and promoters of a tournament to have a method that could both attract and engage the casual fan during the course of a tournament, and, retain the attention and engagement of a more serious fan, even after their favorite teams may have lost during the course of a tournament.

### BRIEF SUMMARY OF THE INVENTION

An embodiment of the present invention comprises a method to create, enhance and retain the attention of serious, casual and new fans during the course of a sports tournament. In particular, the method is directed to leveraging the concept of participation in tournament brackets to create a simpler and more flexible method of engaging all fans during the course of a tournament.

In one aspect, the method comprises providing an abbreviated interface to allow a fan to select and predict winning teams at certain stages or “rounds” of a tournament. In a preferred embodiment, the method comprises the provision of a bracket interface for completion by a fan in later rounds of a tournament. For example, in one embodiment, for the NCAA Men's Division 1 basketball tournament, casual fans would fill out a bracket only for the subsequent rounds in which the ELITE EIGHT teams are competing. Each casual fan would select his or her predicted winning teams beginning with the ELITE EIGHT round at the same time as serious fans are completing a full bracket associated with all 64 teams in the MARCH MADNESS tournament. Once the tournament has progressed to the ELITE EIGHT round, each casual fan's predicted winners are compared to the actual results of the tournament. Where the fan's selections are incorrect, the fan is offered one or more opportunities to correct their incorrect predictions. The fan may obtain these correction opportunities free, via payment, submittal of a code and other similar forms of acquisition. At the end of a tournament, bracket predictions are compared and scored and one or more fans may be awarded with promotions or other gifts.

In another aspect, the method also supports continued participation by serious fans that are willing to complete an entire bracket at the outset of the tournament. As with the casual fan that has elected to fill out the bracket at a later round, the serious fan is provided with the opportunity to correct his or her incorrect predictions when the tournament has progressed to the ELITE EIGHT level.

Consequently, the enhanced simplicity of participation and the ability to update selections at a later round will tend to cause increased participation in the tournament by serious, casual and new fans. As a direct result, advertisers, sponsors and promoters of the tournament will receiver greater attention to the products advertised during the tournament for a longer duration. Due to the complexity of tracking and correcting selections, and, comparing results across millions of entries into bracket competitions, the method is preferably computer-implemented and administered across the Internet or via networked applications.

### BRIEF DESCRIPTION OF THE SEVERAL VIEWS OF THE DRAWINGS

These and other features, aspects and advantages of various embodiments of the present invention will become better understood with regard to the following description, appended claims, and accompanying drawings where:

FIG. 1 is a flow chart illustrating the high-level process for managing a tournament bracket competition according to the invention;

FIG. 2 is a flow chart illustrating the process for making initial predictions;

FIG. 3 is a flow chart illustrating the process for determining correction counts;

FIG. 4 is a flow chart illustrating the process for completing the first correction round;

FIG. 5 is a flow chart illustrating the process for completing the second correction round;

FIG. 6 is a flow chart illustrating the process for scoring and awarding prizes;

FIG. 7 is an illustration of an exemplary full seed bracket;

FIG. 8 is an illustration of an exemplary tournament results bracket;

FIG. 9 is an illustration of an exemplary tournament full prediction bracket;

FIG. 10 is an illustration of an exemplary tournament partial seed bracket;

FIG. 11 is an illustration of an exemplary tournament partial prediction bracket;

FIG. 12 is an illustration of an exemplary tournament original prediction bracket;

FIG. 13 is an illustration of an exemplary tournament updated prediction bracket;

FIG. 14 is an illustration of a first alternative bracket;

FIG. 15 is an illustration of a second alternative bracket;

FIG. 16 is an illustration of a third alternative bracket.

The accompanying drawings numbered herein are given by way of illustration only and are not intended to be limitative to any extent. Commonly used reference numbers identify the same or equivalent parts of the claimed invention throughout the several figures.

### Objectives

A first objective is to provide a medium and mechanism by which advertisers may increase their ability to market their goods and services to consumers by leveraging consumer interest in competitive events, particularly sporting events.

Another objective is to increase consumer recognition and goodwill towards advertisers' brands.

Another objective is to provide a tournament format that encourages consumers to have sufficient interest in a sporting event to spend the time to predict the outcome of the sporting events.

Another objective is to provide a medium by which advertisers may generate consumer attention and interest in the advertiser's goods and services through tournament promotions and awards of prizes to winning consumers.

Another objective is to retain consumer interest and attention throughout long-duration tournaments, including revitalizing interest at key intervals throughout the tournament.

Another objective is to simplify the tournament participation structure to generate consumer interest and attention among casual fans who do not traditionally participate in tournaments.

Another objective is to provide a means for retaining consumer interest and attention among serious fans after their favorite teams or predicted winners have been eliminated.

### DETAILED DESCRIPTION

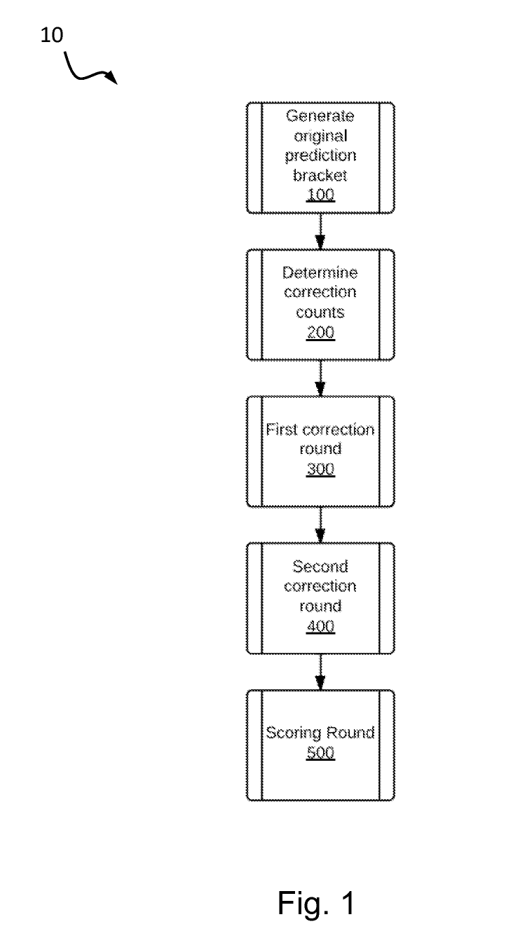

Referring to FIG. 1, a top-level flowchart of an embodiment of the method 10 to support and enhance fan participation in a tournament bracket competition is shown. At the outset, each fan, (hereinafter, a participant) generates an original prediction bracket 100. During the original prediction bracket step 100, each participant will generate a plurality of outcome predictions. Outcome predictions are predictions such as which team will win any given sporting event, and what the final score in that sporting event will be. As results of the tournament become known, and a participant's incorrect predictions become known, the method 10 tallies correction counts in step 200 for each participant. Thereafter, each participant receives an option to use one or more corrections in a first correction round 300. The method 10 populates the bracket according to the participant's selected corrections. Subsequently, each participant has the opportunity to select new predicted winners in a second correction round 400 based upon selected corrections in the first correction round 300. At the end of the tournament, during scoring round 500, the method 10 tallies each participant's score based on one or more algorithms and scoring structures. Based on those scores, successful bracket competitors are selected and awards and prizes may be distributed.

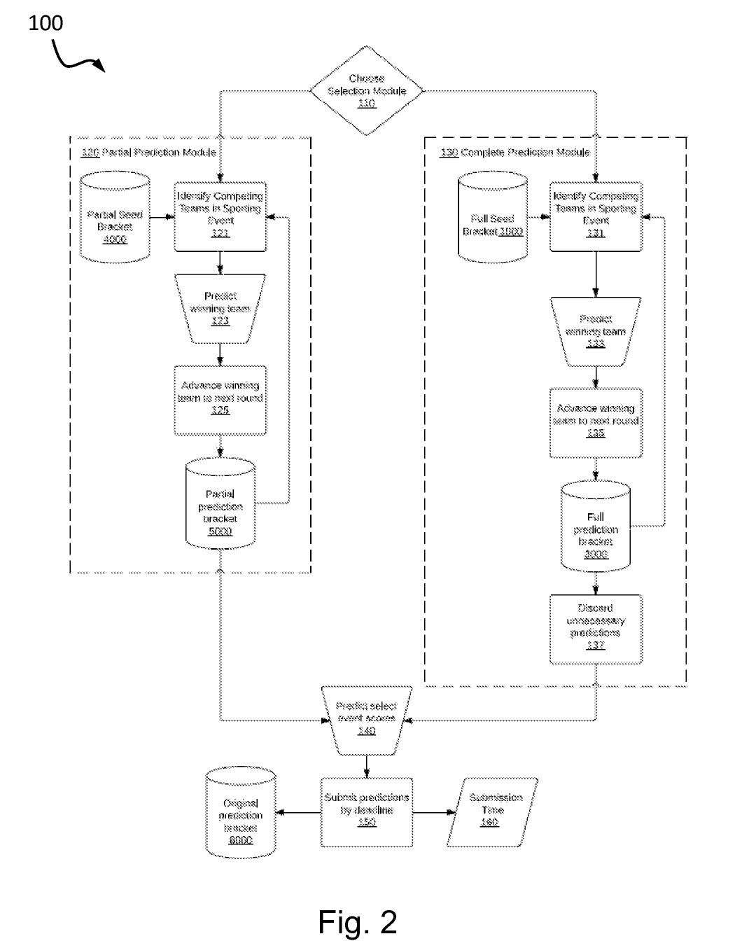

Referring to the flowchart of FIG. 2, the process for making initial original predictions 100 is shown. At the outset, a participant is given the option to choose a bracket selection module at step 110. A participant may select between the partial prediction module 120 or the complete prediction module 130.

For the participant choosing the partial prediction module 120, the participant is first provided access to a partial seed bracket 4000. The partial seed bracket 4000 is an abbreviated segment of the entire tournament bracket where the participant predicts winners only for sporting events related to the second phase of the tournament.

For example, in use, the method 10 selecting the partial prediction module 120 may be applied to the NCAA basketball tournament. In this embodiment, the sports tournament is divided into two phases. The first phase is comprised of the round of sixty-four, the round of thirty-two, and the round of sixteen, or SWEET SIXTEEN. The second phase begins when the eight winners of the SWEET SIXTEEN round are known. The second phase is comprised of the round of eight, or ELITE EIGHT, the round of four, or FINAL FOUR, and the final round. A participant is provided with the opportunity to select and predict winning teams for the bracket beginning with the ELITE EIGHT round. In step 121, the participant selects which teams they believe will advance to the ELITE EIGHT round. The partial seed bracket 4000 illustrates which teams may advance to each of the eight available ELITE EIGHT positions. These predictions are stored as the partial prediction bracket 5000. These teams are grouped into pairs, the pairing determined by the configuration of the partial seed bracket 4000. For each sporting event comprised of two teams in competition, a participant predicts which of the two teams they believe will win 123. The predicted winning team is advanced to the next round in step 125 by recording the prediction on an entry form, specifically the partial prediction bracket 5000. The winning teams in one round then compete again in the next round, the pairing rules dictated by the partial seed bracket 4000 configuration. The participant continues to identify competing teams 121, predict winning teams 123, and advance winning teams to the next round 125 for the remainder of the tournament. Each participant's predictions are recorded to populate the participant's personal partial prediction bracket 5000.

In another aspect, a participant predicts game scores for selected sporting events 140. In one version, a participant predicts scores for the final round and the two semifinal rounds. Once all team and score predictions have been made, the participant submits the predictions by a predetermined deadline 150. The participant's predicted winners are then transferred from the partial prediction bracket 5000 to create the participant's original prediction bracket 6000. The submission time 160 is recorded.

Referring still to FIG. 2, a participant may alternatively select the complete prediction module 130. For the participant choosing the complete prediction module 130, the participant is first provided access to a full seed bracket 1000. The full seed bracket 1000 initially provides the first round brackets in step 131 fully populated with all competing teams, which is established at the outset of the tournament. For each sporting event comprised of two teams in competition, a participant predicts which of the two teams they believe will win 133. The predicted winning team is advanced to the next round in step 135 by recording the prediction on an entry form, specifically the full prediction bracket 3000. The winning teams in one round then compete again in the next round, the pairing rules dictated by the full seed bracket 1000 configuration. The participant continues to identify competing teams 131, predict winning teams 133, and advance winning teams to the next round 135 for the remainder of the tournament. Each participant's predictions are recorded to populate the participant's personal full prediction bracket 3000.

In step 137, unnecessary predictions are discarded. Unnecessary predictions are any predictions that are required to completely fill out the full prediction bracket 3000, but are not required to completely fill out an equivalent partial prediction bracket 5000. In one embodiment, applied to the NCAA basketball tournament, both the full prediction bracket 3000 and the partial prediction bracket 5000 require predictions of which teams will advance to the ELITE EIGHT round, which teams will advance to the FINAL FOUR round, which teams will advance to the final round, and which team will win the final round. These predictions are not discarded at step 137. However, the predictions of which teams will advance from the round of 64 to the round of 32, and which teams will advance from the round of 32 to the round of 16, are required on the full prediction bracket 3000 but not the partial prediction bracket 5000. These predictions are discarded at step 137.

In another embodiment, the method 10 is applied to the NCAA basketball tournament where participants having selected the complete prediction module 130 are also offered the opportunity to generate an original prediction bracket 160 in a manner consistent with those participants that selected the partial prediction module 120. Again, a participant predicts game scores for selected sporting events 140. Although the method supports the ability to allow participants to predict game scores for all sporting events, which adds another dimension to the bracket assessment, in one version, a participant predicts scores for the final round and the two semifinal rounds. Once the participant has completed the bracket and all predictions, the participant submits his or her predictions by a predetermined deadline 150. The predicted winners are transferred from the full prediction bracket 3000 to the participant's original prediction bracket 6000. Submission time is recorded 160.

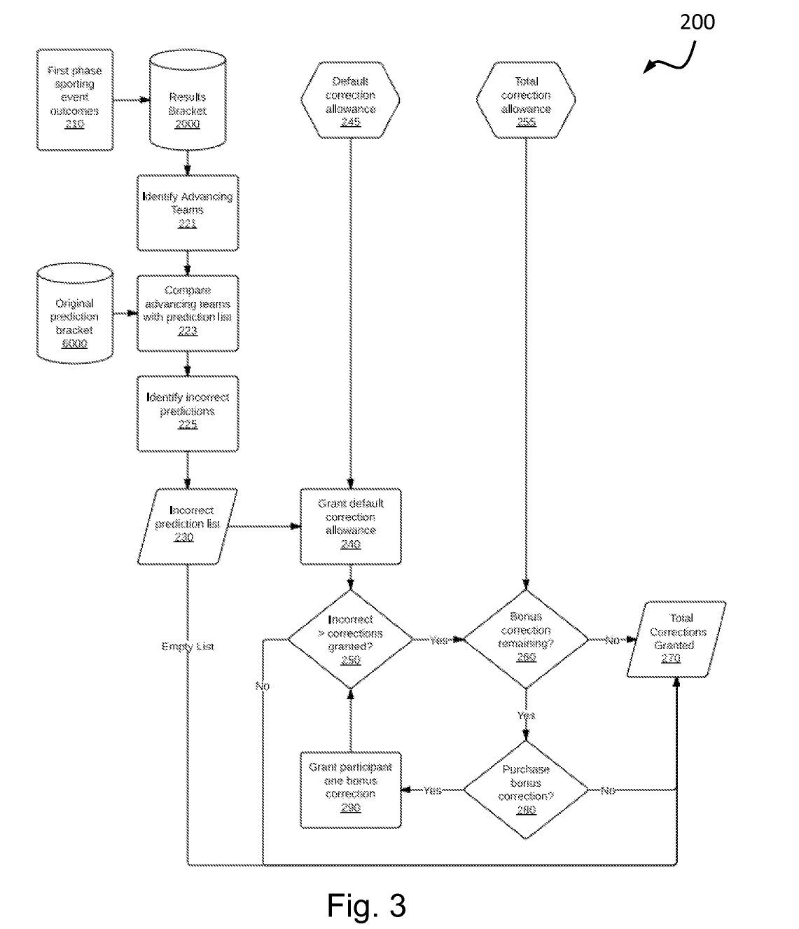

Referring to FIG. 3, a flowchart illustrating the steps for determining correction counts 200 is shown. Before determining correction counts, participants must wait until all of the sporting events in a first phase of the tournament have concluded and actual winners determined. In step 210, sporting event outcomes for a first phase are recorded in a results bracket 2000. In step 221, which teams advance from the first phase of the tournament to the second phase of the tournament are determined according to the method 10 based on the results bracket 2000.

In one embodiment, applicable to the NCAA basketball tournament, participants wait until three rounds have completed and exactly eight teams remain at the ELITE EIGHT level. The method 10 identifies which teams advance to the ELITE EIGHT level in step 221, and compares the advancing teams in step 223 against each participant's original prediction bracket 6000 to identify each participant's incorrect predictions in step 225. Incorrect predictions are recorded in an incorrect prediction list 230. If the incorrect prediction list 230 is populated, each participant may be granted a default number of corrections in step 240 up to a default correction allowance 245, but no more than the number of incorrect predictions on the incorrect prediction list 230. The number of total corrections granted is recorded 270. The default correction allowance 245 is determined before the tournament begins and revealed to participants. If a participant's incorrect prediction list is empty, the participant is deemed to need no corrections, recording zero total corrections granted 270 and concluding the determine correction counts step 200 for this participant.

The grant of additional corrections beyond the default correction allowance 245 is determined iteratively. In step 250, each participant's incorrect prediction list 230 is compared with the total corrections granted 270. If the number of incorrect predictions on the incorrect prediction list 230 is less than or equal to the total corrections granted 270, the total corrections granted 270 are recorded and the determine correction counts step 200 is concluded for this participant. If the number of incorrect predictions on the incorrect prediction list 230 is greater than the total corrections granted 270, a check is made to determine if the participant is allowed any bonus corrections in step 260. In step 260 allowed bonus corrections are determined by comparing the total corrections granted 270 with the total correction allowance 255. The total correction allowance 255 is determined before the tournament begins and revealed to participants. The total corrections granted 270 is a count of how many default corrections are granted in step 240 plus the number of times a participant has purchased a bonus correction in step 290.

In granting additional corrections, a participant's total correction count 270 is compared with the total correction allowance 255. If the participant's total correction count 270 is equal to the total correction count 255, the total corrections granted 270 are recorded and the determine correction counts step 200 is concluded for this participant.

If the participant's correction count 270 is less than the total correction allowance 255, the participant is presented with an option to purchase one or more additional bonus corrections 280 for a monetary fee. A monetary fee is a payment of money to a party in exchange for a bonus correction. In order to boost brand goodwill, a user of the method 10 may instead replace the monetary fee model with a charitable donation model. If the charitable donation model is used, a user of the method 10 facilitates a payment of money to a charity in exchange for a bonus correction. In order to boost brand recognition, a user of the method 10 may instead replace the monetary fee model with a promotional code model. If the promotional code model is used, a user of the method 10 will provide the opportunity for consumers to obtain promotional codes as part of an advertising or sales campaign. Consumers may then redeem a promotional code to obtain a bonus correction.

If the participant chooses not to purchase a bonus correction, the participant's total corrections granted 270 are recorded, concluding the determine correction counts step 200 for this participant. If the participant chooses to purchase a bonus correction 290, the total corrections granted 270 is incremented by one. This process is repeated by once again comparing in step 250 the incorrect prediction list 230 with the total corrections granted 270, until the total corrections granted 270 is a) equal to the number of incorrect predictions on the incorrect prediction list 230, b) the participant has no bonus corrections remaining 260, or c) the participant declines to purchase a bonus correction 280.

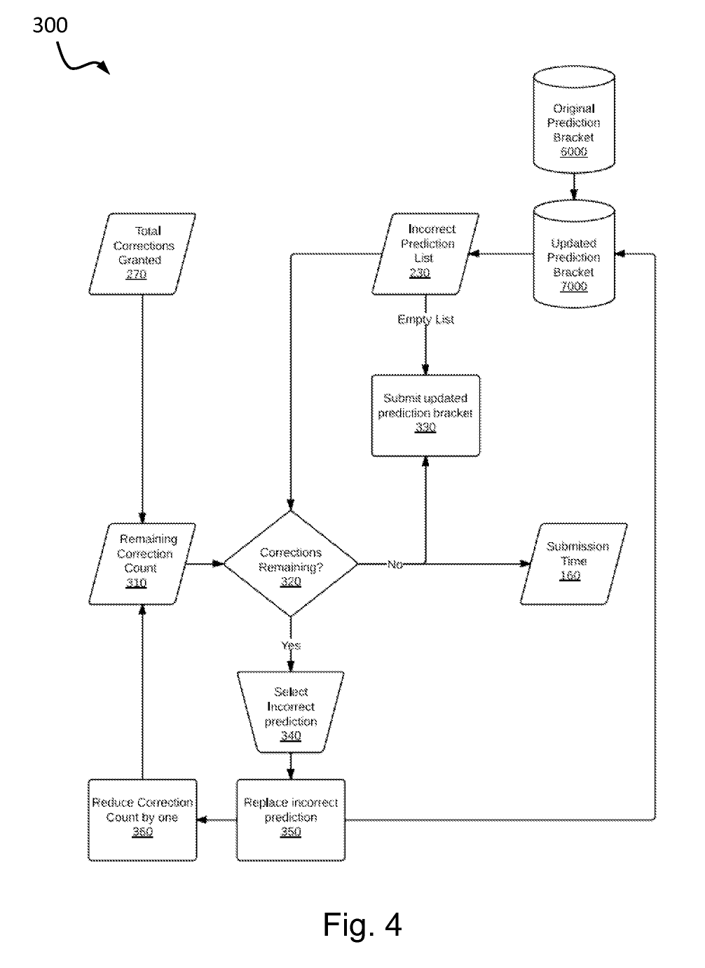

Referring to FIG. 4, a flowchart illustrating the additional steps associated with first round correction 300 is shown. At the outset, for each participant, the original prediction bracket 6000 is duplicated to generate an updated prediction bracket 7000. In addition, a remaining correction count 310 is generated; initially equal to the participant's total corrections granted 270. The incorrect prediction list 230 is read to determine if the participant has any incorrect predictions. In step 330, if the incorrect prediction list 230 is empty, the updated prediction bracket 7000 is stored. Submitting the updated prediction bracket 330 concludes the first correction round 300 for this participant.

If the incorrect prediction list 230 is not empty, the remaining correction count 310 is read to determine whether the participant has any corrections remaining 320. In step 330, if the remaining correction count 310 is zero, the updated prediction bracket 7000 is stored. The submission time 160 is recorded, overwriting any earlier submission time 160. Submitting the updated prediction bracket 330 concludes the first correction round 300 for this participant. If the remaining correction count 310 is positive, the participant is prompted to select an incorrect prediction 340 from the incorrect prediction list 230. After the participant selects an incorrect prediction, the incorrect prediction is replaced 350 with the associated correct prediction and the updated prediction bracket 7000 is updated and the remaining correction count 310 is reduced by one in step 360. The first correction round 300 repeats, beginning with the creation of the incorrect prediction list 230 from the updated prediction bracket 7000, until the participant's correction count 310 is zero or the incorrect prediction list 230 is empty.

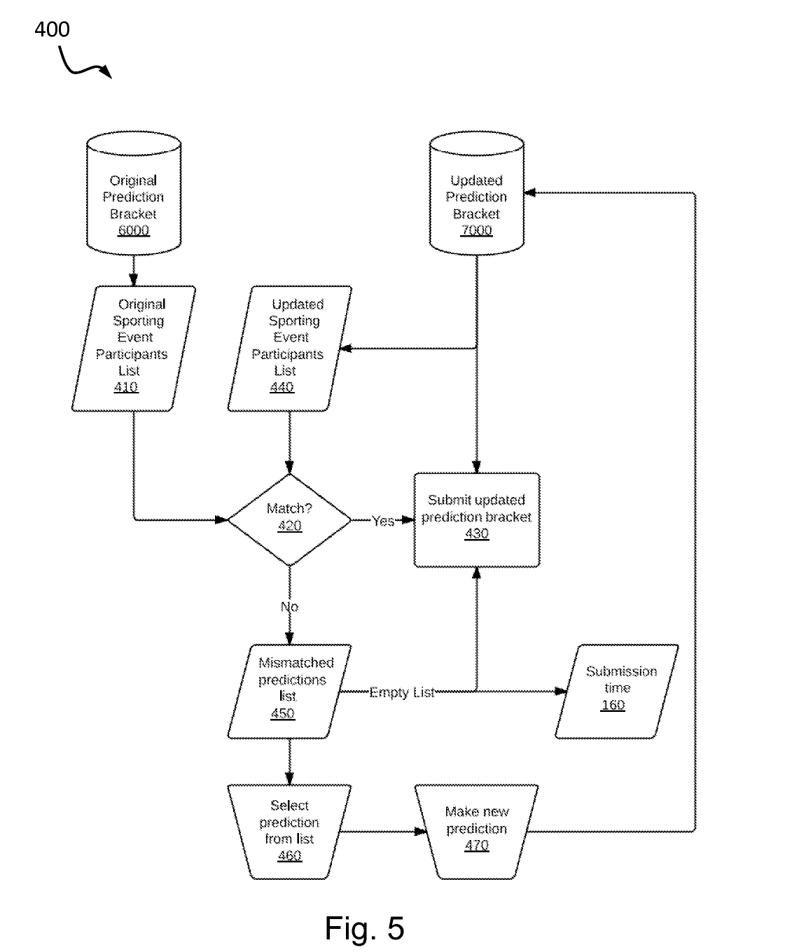

Referring to FIG. 5, a more detailed flowchart illustrating the additional steps associated with the second correction round step 400 is shown. For each of the sporting events in the original prediction bracket 6000, the two predicted participants are recorded in the original sporting event participants list 410. For each of the sporting events in the updated prediction bracket 7000, the two predicted participants are recorded in the updated sporting event participants list 440. The original sporting event participants list 410 is compared in step 420 with the updated sporting event participants list 440. If the original and updated lists 410, 440 match, the updated prediction bracket 430 is submitted, concluding the second round corrections step 400 for this participant. If original and updated lists 410, 440 do not match, a list of sporting events with mismatched participant predictions is generated creating a mismatched predictions list 450. In step 460, the participant is prompted to select a prediction from the mismatched predictions list 450. The participant is prompted to replace their original incorrect prediction with an updated new prediction 470, choosing a winner from one of the sporting event participants on the updated sporting event participants list 440. If the original predicted winner is still a predicted winner on the updated sporting event participants list 440, the participant's replacement prediction may be identical to the original prediction. The updated prediction is saved in the updated prediction bracket 7000.

The second correction round 400 repeats, beginning with creating an updated sporting event participants list 440, with two important differences. First, when the mismatched participants list 450 is created on subsequent cycles, sporting events that the participant has already selected in step 460, and updated in step 470, are not included. In this way, the number of predictions on the mismatched predictions list will likely diminish on subsequent cycles. Second, since predicted sporting event winners in one round become predicted sporting event participants in the following round, replacing an original prediction with an updated prediction 470 can create new discrepancies between the original sporting event participants list 410 and the updated sporting event participants list 440. Once the mismatched predictions list 450 becomes an empty list, the participant submits the updated prediction bracket in step 430 and a new submission time 160 is recorded, overwriting any earlier submission time 160.

In one version, where the participant selects a prediction with mismatched participants 460 which is also a prediction where the participant is prompted to predict the final score 140, the participant is also allowed to update his or her final score prediction for the select round. However, the participant is only allowed to replace the score prediction for teams represented in the updated sporting event participants list 440 but not represented in the original sporting event participants list 410.

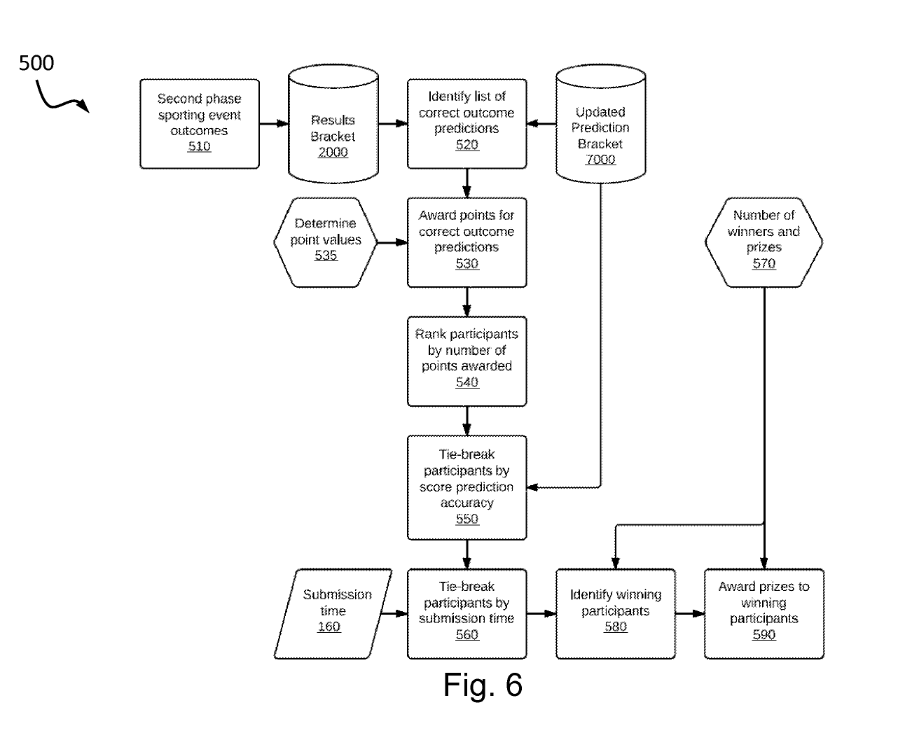

Referring to FIG. 6, a more detailed flowchart illustrating the additional steps associated with the scoring round step 500 is shown. Before the scoring round 500 may begin, the participants must wait until all remaining sporting events have concluded and a champion determined. First, the second phase sporting event outcomes are recorded 510 in the results bracket 2000, including the actual final scores the participants are prompted to predict 140. The actual results for each sporting event are compared 520 against each participant's updated prediction bracket 7000. For each correct prediction, the participant is awarded a point value 530. The correct prediction point values are determined 535 before the tournament begins and revealed to the participants.

In one version, all correct predictions are awarded an equal point value. In another version, correct predictions for later tournament rounds are awarded more points than correct predictions in earlier tournament rounds. A point total is the sum of all points awarded to a participant at step 530. All participants are ranked based on their point total in step 540, with participants awarded more points receiving a higher rank than participants awarded fewer points. In step 550, ties are broken by awarding a higher rank to participants who predicted the select event scores during step 140 with greater accuracy. In step 560, remaining ties are broken by awarding a higher rank to participants having an earlier submission time 160.

Once the participant's rankings have been determined and all ties resolved, winning participants 580 are identified, with the number and type of prize winners determined 570 before the tournament begins and revealed to the participants. Participants receive various prizes 590 such as awards, coupons, prizes and other gifts and opportunities based on their rank.

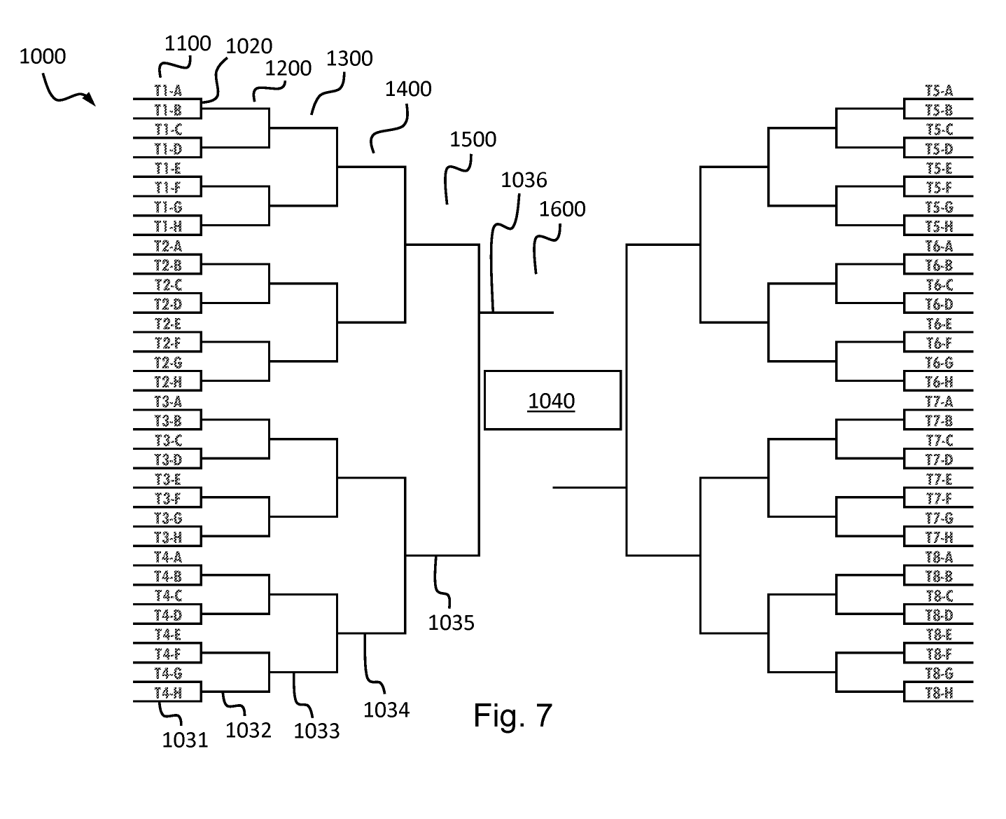

Referring to FIG. 7, a sample full seed bracket 1000 is shown. In one embodiment, 64 teams, labelled T1-A through T8-H, compete in the tournament. A tournament selection committee assigns each team to one of the 64 available spots 1031 in the first round 1100. For each round, team pairs compete in single-elimination format, each pairing designated on the seed bracket by a vertical line 1020 connecting the two competing teams. A single-elimination format is a tournament format in which a team is eliminated from the tournament whenever they lose a single game. Referring to the left side of the seed bracket 1000, winning teams are advanced left-to-right. The winner of the first round 1100 advances to the second round 1200, designated by recording the winning team's name on the second round empty space 1032 to the immediate right. The losing team is eliminated from the tournament. The winner of the second round 1200 advances to the third round 1300, designated by recording the winning team's name on the third round empty space 1033 to the immediate right. The winner of the third round 1300 advances to the fourth round 1400, designated by recording the winning team's name on the fourth round empty space 1034 to the immediate right. The winner of the fourth round 1400 advances to the fifth round 1500, designated by recording the winning team's name on the fifth round empty space 1035 to the immediate right. The winner of the fifth round 1500 advances to the final round 1600, designated by recording the winning team's name on the final round empty space 1036 to the immediate right. On the right side of the seed bracket 1000, advancement of teams from one round to the next proceeds in the same fashion except right-to-left. The winner of the final round 1600 is recorded in the box 1040 in the center of the seed bracket 1000.

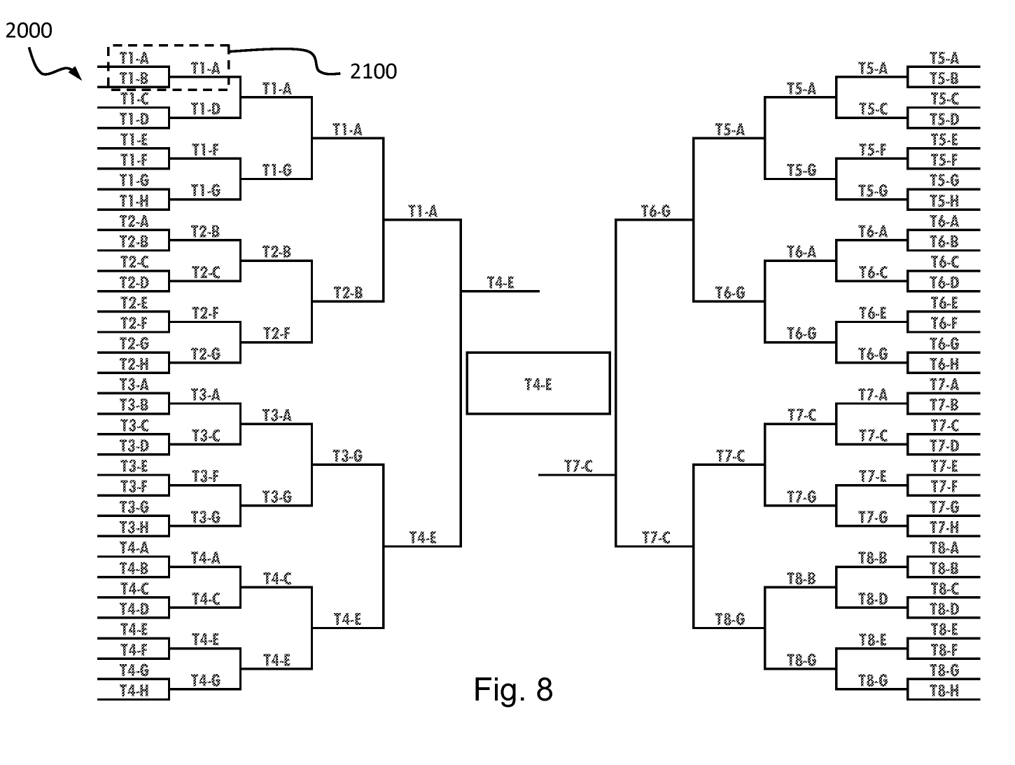

Referring to FIG. 8, a sample results bracket 2000 is shown. This figure demonstrates how the actual results of a tournament are recorded for visual display and then read by a participant. For example, by reading the first entry 2100 on the bracket 2000, teams T1-A and T1-B are scheduled to compete in the first round 1100. According to the sample results bracket 2000, team T1-A proceeds to the second round 1200, while team T1-B is eliminated from the 22 tournament. In the second round 1200, team T1-A is scheduled to compete against team T1-D, and so on. Furthermore, the two teams that proceed to the final round are teams T4-E and T7-C. Team T4-E wins the championship.

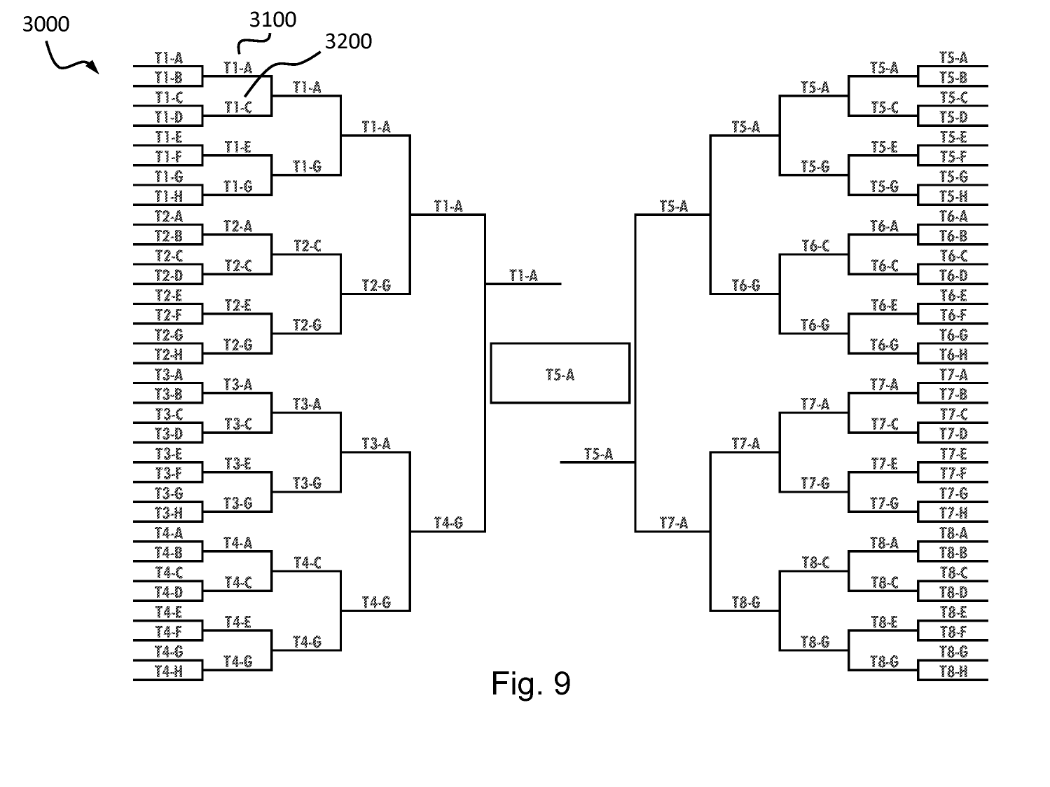

Referring to FIG. 9, a sample full prediction bracket 3000 is shown. Rather than recording the actual sporting event results, the full prediction bracket instead records one participant's predictions of what the outcomes will be. These predictions may be correct or incorrect. For example, in the match between teams T1-A and T1-B, the full prediction bracket contains the correct prediction that team T1-A will advance 3100. However, when compared against the results bracket 2000 in FIG. 8, in the match between team T1-C and T1-D, the participant's full prediction bracket contains an incorrect prediction that team T1-C will advance 3200 rather than T1-D.

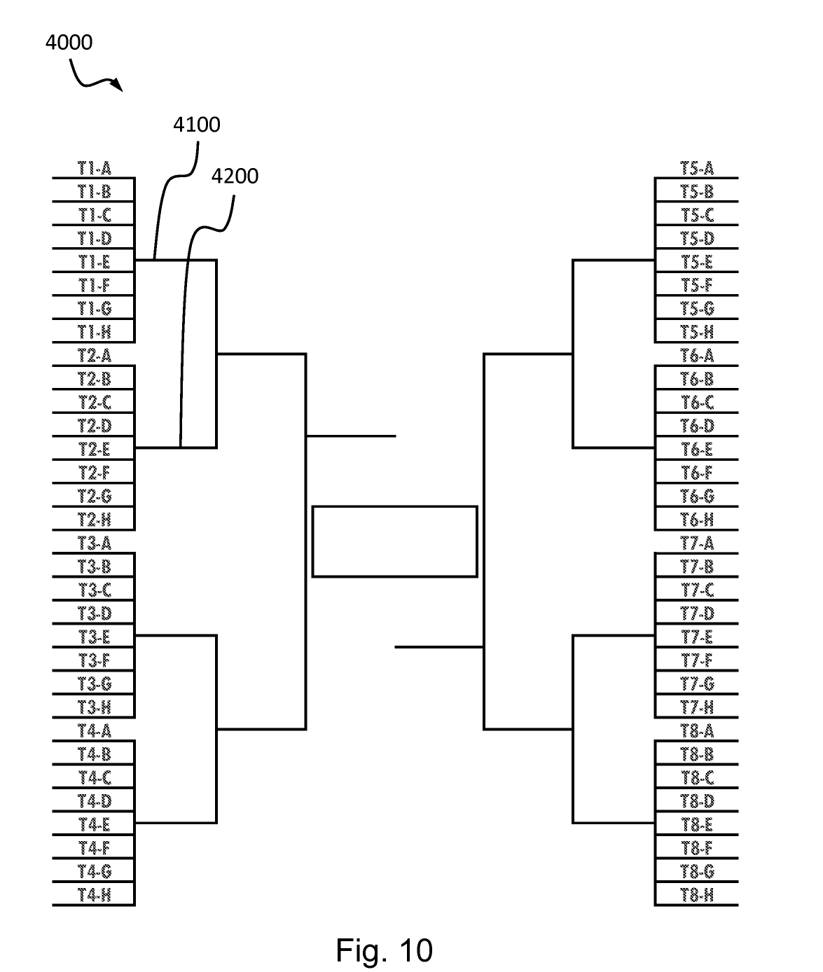

Referring to FIG. 10, a sample partial seed bracket 4000 is shown. Like the sample full seed bracket 1000 shown in FIG. 1, the sample partial seed bracket 4000 communicates how the various teams compete for advancement. However, rather than communicating the specific team pairings, the sample partial seed bracket only communicates team matches by group. For example, teams T1-A through T1-H all compete for a single advancement position 4100, while teams T2-A through T2-H all compete separately for a second advancement position 4200.

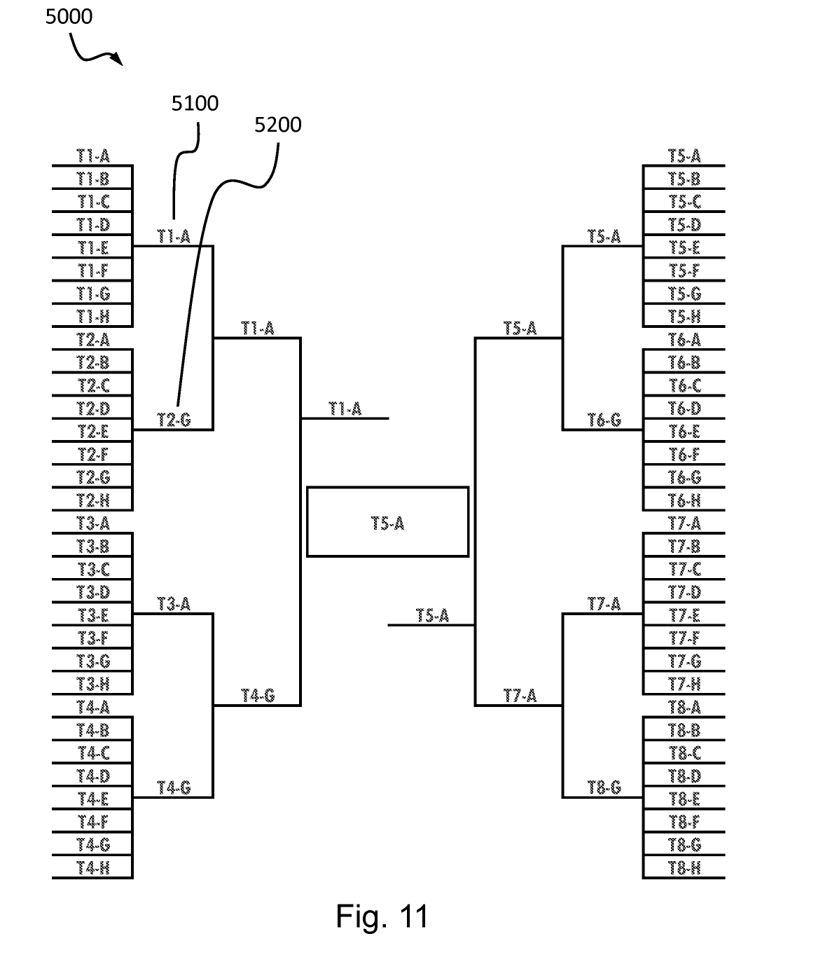

Referring to FIG. 11, a sample partial prediction bracket 5000 is shown. Rather than recording the actual sporting event results, the partial prediction bracket 5000 instead records one participant's predictions of what the outcomes will be. Furthermore, rather than predicting which teams advance in earlier rounds of the full bracket, the partial prediction bracket 5000 records only one participant's predictions of which single team from any group will advance through several rounds. These predictions may be correct or incorrect. For example, in the grouping of teams T1-A through T1-H, the partial prediction bracket contains the correct prediction that team T1-A will advance 5100 to the first round of the partial prediction bracket 5000. However, when comparing to the results bracket 2000 of FIG. 8, in the grouping of teams T2-A through T2-H, the partial prediction bracket 5000 contains an incorrect prediction that team T2-G will advance 5200 rather than team T2-B.

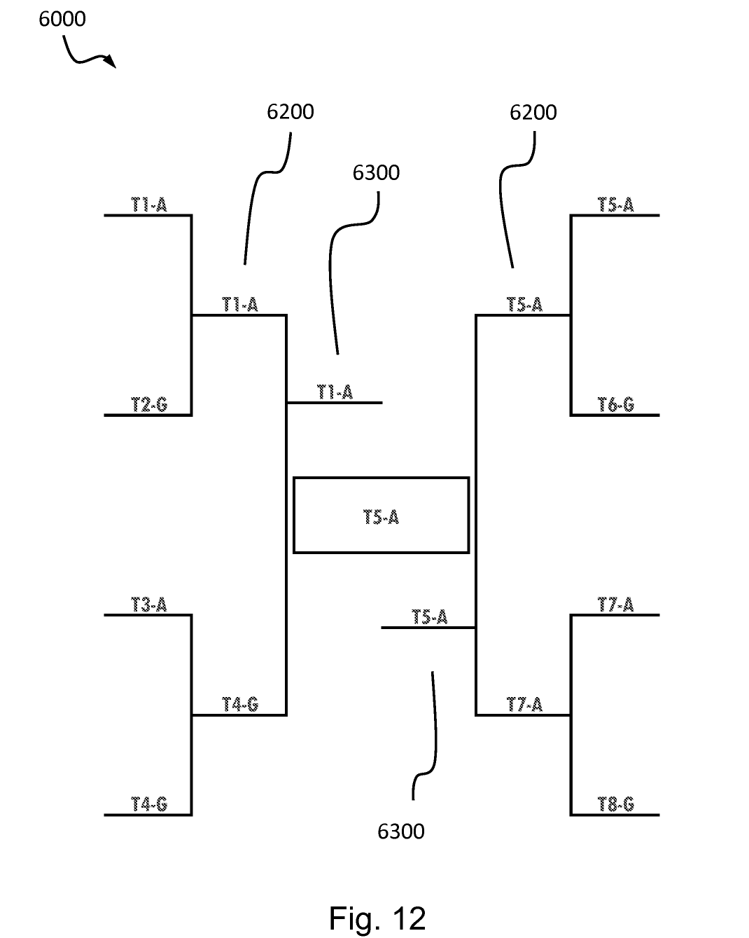

Regardless of whether the participant chose to fill out a complete or partial bracket, both methods as described will result in a list of predictions until a champion is determined. Referring to FIG. 12, a sample original prediction bracket 6000 is shown. The sample full prediction bracket 3000 and the sample partial prediction bracket 5000 would both produce an original prediction bracket 6000. In addition to predicting which teams will win each sporting event, the participant also predicts the final score for the final round 6300 and semifinal rounds 6200. Once all predictions are completed, the participant records the predictions on the original prediction bracket 6000 and submits the original prediction bracket 6000 where the submission time 160 is recorded.

To illustrate the method 10 association with the present invention, the sample original prediction bracket 6000 of FIG. 12 is compared with the sample results bracket 2000 of FIG. 8. Upon inspection, one will note that there are four correct team advancement predictions and four incorrect team advancement predictions. In this example, the original prediction bracket 6000 correctly predicted that teams T1-A, T5-A, T6-G, and T8-G would advance. However, the original prediction bracket 6000 incorrectly predicted that teams T2-G, T3-A, T4-G, and T7-A would advance. In this example, correct team advancement predictions would have been teams T2-B, T3-G, T4-G, and T7-C, respectively.

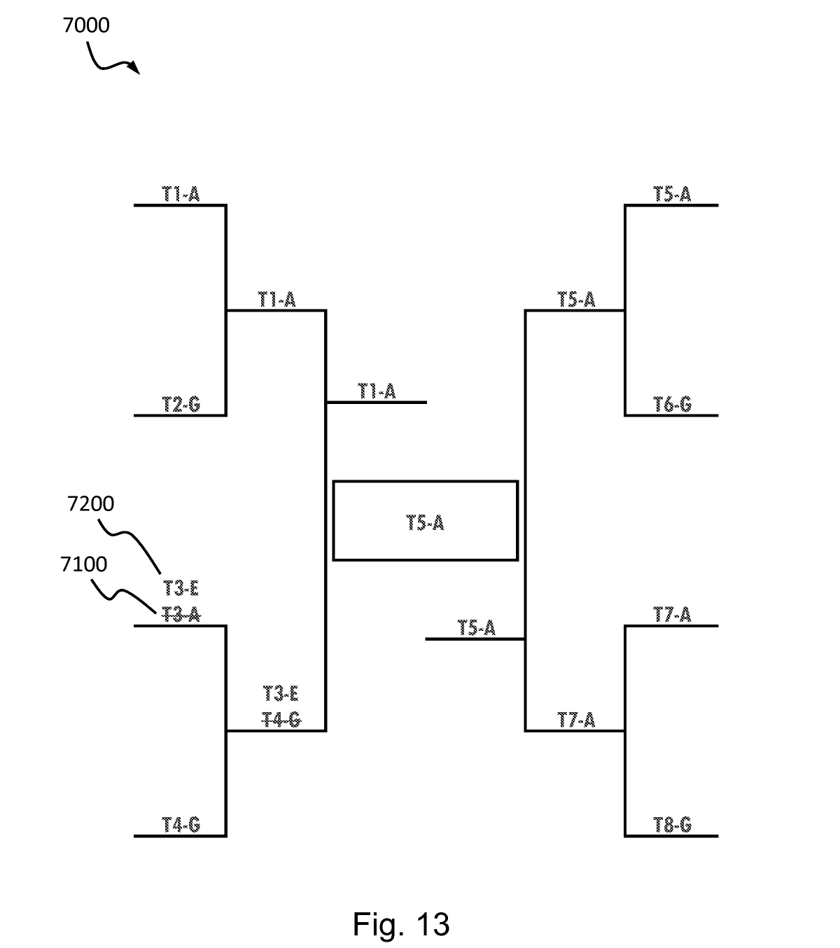

Referring now to FIG. 13, a sample updated prediction bracket 7000 is shown. In this example, the participant has chosen to fix the incorrect team advancement prediction for team T3-A. The incorrect team advancement prediction for team T3-A 7100 is therefore replaced with the correct team advancement prediction 7200, team T3-E. In this example, the participant does not fix any other team advancement predictions.

Comparing the sample original prediction bracket 6000 with the sample updated prediction bracket 7000, multiple second round corrections are allowed. In the original prediction bracket 6000, the participant predicted that teams T3-A and T4-G would compete. However, in the updated prediction bracket 7000, the participant now predicts that teams T3-E and T4-G will compete. Therefore, the participant is allowed to provide a new prediction for this round. In this example, the participant chooses to predict that team T3-E will now advance. This change triggers another discrepancy between the original prediction bracket 6000 and the updated prediction bracket 7000. In the original prediction bracket 6000, the participant predicted that teams T1-A and T3-A will compete. However, in the updated prediction bracket 7000, the participant now predicts that teams T1-A and T3-E will compete. Therefore, the participant is allowed to provide a new prediction for this round. In this example, the participant chooses to preserve the original prediction that team T1-A will advance.

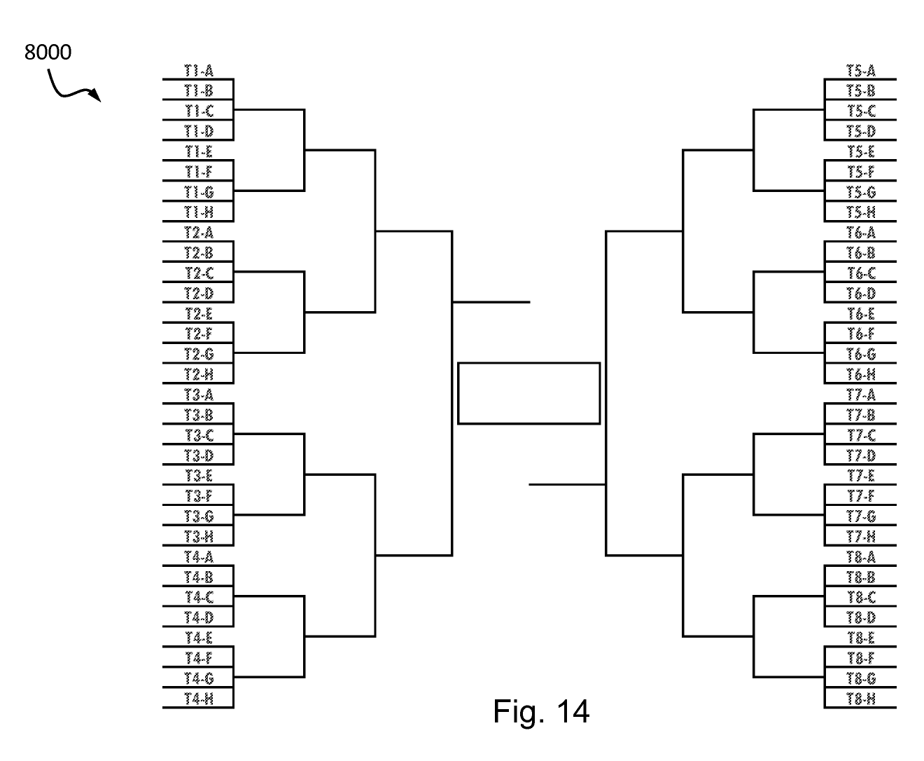

In the embodiments previously shown, the teachings of the invention are applied to a tournament featuring 64 teams in a single-elimination format. In alternate embodiments, the teachings of this invention apply equally well to other tournament formats. Referring to FIG. 14, a first alternative embodiment 8000 featuring a double-elimination format in the first round is shown. An example of an applicable tournament following this format is the baseball tournament organized by the NCAA, often referred to by the trademark “COLLEGE WORLD SERIES.” A double-elimination format is a tournament format in which a team is eliminated from the tournament whenever they lose a second game. When advancing from the first to the second round, four teams compete together for one position. The same four teams will compete with one another across a plurality of games until three out of four teams have lost a second game. The double-elimination format may be extended to any multiple-elimination format wherein a team is eliminated after losing their third round, their fourth round, et cetera. An original prediction bracket may be generated by predicting the winners of each game or by predicting only which team advances to the next round.

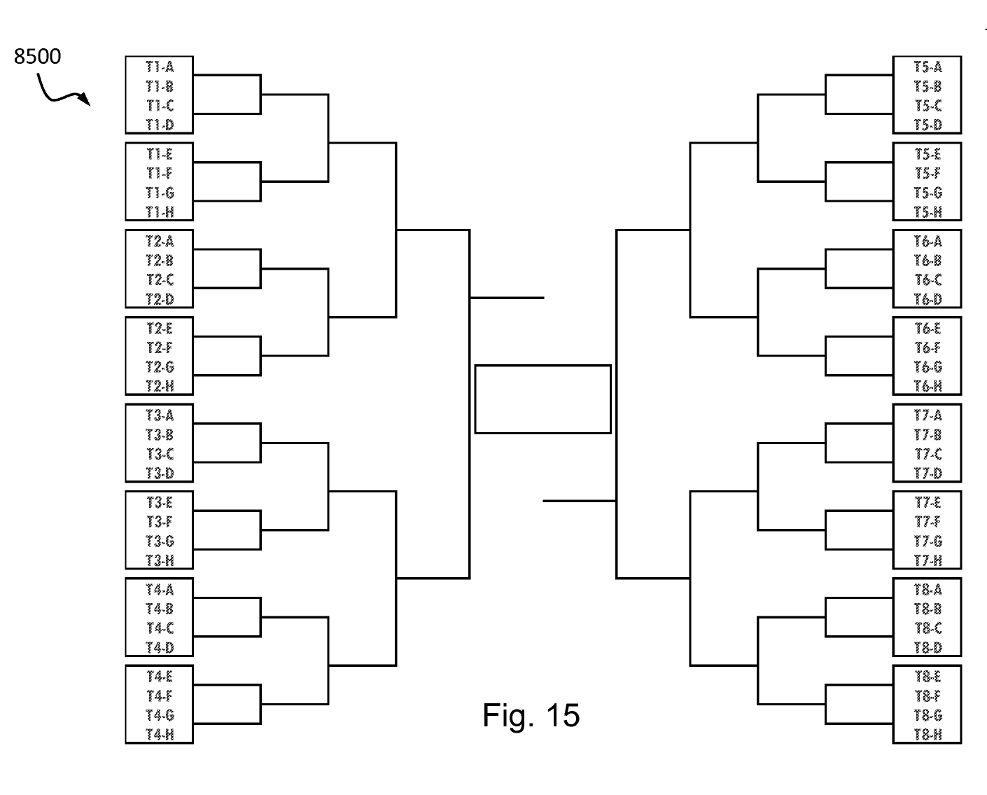

Now referring to FIG. 15, a second alternative embodiment 8500 featuring a round-robin format during the first round is shown. An example of an applicable tournament following this format is the international soccer tournament organized by the Federation Internationale de Football Association, often referred to by the trademark “FIFA WORLD CUP.” In a round-robin format, teams are initially placed in a group of four, with each group member playing every other group member exactly once. The teams are ranked based on their number of wins, ties, losses, and points scored, with the top two teams advancing to the next round. Any combination of two teams out of the original four may advance. For example, it is possible for team T1-A and team T1-B to both advance while team T1-C and T1-D are both eliminated. An original prediction bracket may be generated by predicting the winners of each game or by predicting only which teams advance to the next round.

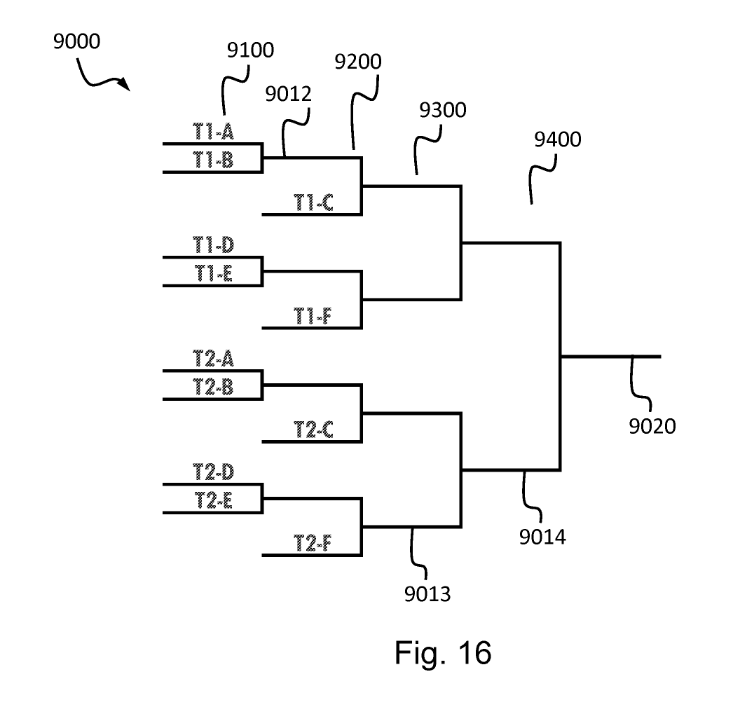

Now referring to FIG. 16, a third alternative embodiment 9000 featuring staggered starting rounds is shown. An example of an applicable tournament format this format is the football tournament organized by the NFL, often referred to as the NFL playoffs. In this example, not all teams are required to compete in the first round 9100. Some of the teams, typically teams with higher seed values, advance automatically to the second round 9200 without competing in the first round 9100. In this embodiment, the number of teams remaining after the first round has decreased from twelve to eight, and the remainder of the tournament proceeds using a single-elimination format.

Referring again to FIG. 16, a more compact bracket format is shown. Referring to the third alternative embodiment 9000, winning teams are advanced left-to-right. The winner of the first round 9100 advances to the second round 9200, designated by recording the winning team's name on the alternative second round empty space 9012 to the immediate right. The losing team is eliminated from the tournament. The winner of the second round 9200 advances to the third round 9300, designated by recording the winning team's name on the alternative third round empty space 9013 to the immediate right. The losing team is eliminated from the tournament. The winner of the third round 9300 advances to the final round 9400, designated by recording the winning team's name on the alternative fourth round empty space 9014 to the immediate right. The losing team is eliminated from the tournament. The winner of the final round 9400 is recorded on the final round empty space 9020 to the immediate right.

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth in the appended claims. The inventions illustratively disclosed herein may be practiced without any element which is not specifically disclosed herein.

I claim:

1. A method for preserving interest and participation in a sports tournament comprising:
a. Establishing a series of sporting events divided into a plurality of rounds, the outcome of each round determining which teams compete with each other in subsequent sporting events;
b. Dividing the tournament rounds into two or more phases, each phase containing a plurality of rounds, where each subsequent phase begins with fewer teams than the previous phase;
c. Providing an entry form to each participant, featuring a plurality of teams arranged according to a tournament format;
d. Making, per participant, outcome predictions for each sporting event and entering those outcome predictions on the entry form;
e. Assigning a point value for each correct outcome prediction on the entry form;
f. Determining the results of each tournament round;
g. At the end of each phase, determining which teams advance to the subsequent phase;
h. For those participants who did not correctly predict which teams would advance to the next phase, allowing the participants one or more corrections on their entry form by replacing one or more incorrect team predictions with the team that actually advances to the next phase;
i. For those participants who make a team correction, allowing derivative corrections on their entry form on any outcome predictions that involves the newly-added team;
j. Calculating a point total for each participant based upon the accuracy of their outcome predictions and the number of corrections issued.

2. The method according to claim 1, where the sports tournament is arranged in a single-elimination format.

3. The method according to claim 2, where the number of teams at the beginning of the tournament is equal to 2ⁿ, where n is a positive integer greater than 1.

4. The method according to claim 3, where the sports tournament is divided into a first phase and a second phase.

5. The method according to claim 4, where the second phase begins when exactly eight teams remain.

6. The method according to claim 1, where the sports tournament is arranged in a multiple-elimination format.

7. The method according to claim 1, where one or more phases are arranged in a round-robin format.

8. The method according to claim 1, where the sports tournament is arranged with staggered starting rounds.

9. The method according to claim 5, where participants need only predict which teams advance to the second phase and not the outcome of individual sporting events in the first phase.

10. The method according to claim 1, where each participant is allowed one correction.

11. The method according to claim 10, where each participant is allowed to make further corrections for a monetary fee.

12. The method according to claim 11, where the monetary fee is in the form of a charitable donation;

13. The method according to claim 10, where each participant is allowed to make further corrections by redeeming a promotional code.

14. The method according to claim 1, where winners are selected by ranking participants by point totals.
